(19) United States
(12) Patent Application Publication
(10) Pub. No.: US 2026/0029537 A1
(43) Pub. Date: Jan. 29, 2026

(54) SYSTEMS AND METHODS FOR THIRD-PARTY TIME AND POSITION AUTHENTICATION

(71) Applicant: TRUSTPOINT, INC., Herndon, VA (US)

(72) Inventor: Patrick SHANNON, Mountain View, CA (US)

(73) Assignee: TRUSTPOINT, INC., Herndon, VA (US)

(21) Appl. No.: 19/139,178

(22) PCT Filed: Dec. 14, 2023
(86) PCT No.: PCT/US2023/084069

§ 371 Date: Jun. 13, 2025

Related U.S. Application Data
(60) Provisional application No. 63/432,438, filed on Dec. 14, 2022.

(51) Int. Cl. G01S 19/03; G01S 19/21; G01S 19/39

(52) U.S. Cl. CPC G01S 19/03; G01S 19/215; G01S 19/396

(57) ABSTRACT

Some implementations herein related to an authentication equipment (AE) that receives an in-phase-quadrature phase (I/Q) spectrum recording of a covert data sequence indicative of received spectra of a signal over which an overt data sequence is transmitted and an overt time and position solution. The AE derives from the overt data sequence. indicating a position and a time at which the position was derived. The AE processes the I/Q spectrum recording to derive an independent time and position solution indicating another position where the I/Q spectrum recording was recorded and another time at which the I/Q spectrum was recorded at the another position. The AE determines whether the overt time and position solution and the independent time and position solution are a match. The AE authenticates the overt time and position solution based on the overt time and position solution and the independent time and position solution being a match.

### CROSS-REFERENCE TO RELATED APPLICATIONS

This application is a National Stage Application of International Application No. PCT/US2023/084069, filed Dec. 14, 2023, which claims the benefit of U.S. Provisional Application No. 63/432,438, filed Dec. 14, 2022, each of which is incorporated herein by reference in its entirety. The present disclosure contains subject matter related to that disclosed in International Application No. PCT/US2022/014274, filed Jan. 28, 2022, and U.S. Provisional Application No. 63/315,679, filed Mar. 2, 2022, each of which is incorporated herein by reference in its entirety.

### BACKGROUND

Position, velocity, and time (PVT) technologies are used in navigation and timing systems. Position technology is associated with determining a location or coordinates of an object in a given space. Time technology is associated with precise measurement and synchronization of time signals. Velocity technology is associated with measuring a rate of change of a position of an object with respect to time.

### SUMMARY

Some implementations provided herein relate to a method associated with third-party time and position authentication. The method may include receiving, by an authentication equipment, an in-phase-quadrature phase (I/Q) spectrum recording of a covert data sequence indicative of received spectra of a signal over which an overt data sequence is transmitted and an overt time and position solution, derived from the overt data sequence, indicating a position and a time at which the position was derived; processing, by the authentication equipment, the I/Q spectrum recording to derive an independent time and position solution indicating another position where the I/Q spectrum recording was recorded and another time at which the I/Q spectrum was recorded at the another position; determining, by the authentication equipment and based on comparing the overt time and position solution and the independent time and position solution, whether the overt time and position solution and the independent time and position solution are a match; and authenticating, by the authentication equipment, the overt time and position solution based on the overt time and position solution and the independent time and position solution being a match.

Some implementations described herein relate to a transceiver device that receives an overt data sequence and a covert data sequence indicative of received spectra of a signal over which the overt data sequence is transmitted; derives, from the overt data sequence, an overt time and position solution indicating a position of the transceiver device and a time at which the transceiver device was at the position; records an in-phase-quadrature phase (I/Q) spectrum recording of the covert data sequence; digitally signs a unique identifier of the transceiver device, the overt time and position solution, and the I/Q spectrum recording to create a unique data representation of the unique identifier, the overt time and position solution and the I/Q spectrum recording; and provides the unique data representation to be entered into an unauthenticated distributed ledger entry of an unauthenticated distributed ledger.

Some implementations described herein relate to a non-transitory computer-readable medium storing a set of instructions, the set of instructions including one or more instructions that, when executed by one or more processors of an authentication equipment, cause the authentication equipment to: receive an in-phase-quadrature phase (I/Q) spectrum recording of a covert data sequence indicative of received spectra of a signal over which an overt data sequence is transmitted and an overt time and position solution, derived from the overt data sequence, indicating a position of the user equipment and a time at which the user equipment was at the position; process the I/Q spectrum recording to derive an independent time and position solution indicating a position where the I/Q spectrum recording was recorded and a time at which the I/Q spectrum was recorded at the position; determine, based on comparing the overt time and position solution and the independent time and position solution, whether the overt time and position solution and the independent time and position solution are a match; and authenticate the overt time and position solution based on the overt time and position solution and the independent time and position solution being a match.

### BRIEF DESCRIPTION OF THE DRAWINGS

FIGS. 1A-1E are diagrams of an example associated with blockchain-based domain registration and device authentication, according to some embodiments of the present disclosure.

FIG. 2 is a diagram of an example environment in which systems and/or methods described herein may be implemented, according to some embodiments of the present disclosure.

FIG. 3 is a diagram of example components of a device associated with third-party time and position authentication, according to some embodiments of the present disclosure.

FIG. 4 is a flowchart of an example process associated with third-party time and position authentication, according to some embodiments of the present disclosure.

FIG. 5 is a flowchart of an example process associated with third-party time and position authentication, according to some embodiments of the present disclosure.

### DETAILED DESCRIPTION OF EXAMPLE EMBODIMENTS

The following detailed description of example embodiments refers to the accompanying drawings. The same reference numbers in different drawings may identify the same or similar elements.

Geolocation satellite systems, such as global navigation satellite systems (GNSSs), provide positioning, navigation, and timing information. For example, GNSSs typically overtly transmit (e.g., broadcast openly for public use or civilian use) GNSS signals (e.g., unencrypted GNSS signals), which include the positioning, navigation, and timing information. Interface control documents, which are typically publicly available, describe specifications, protocols, and parameters of the GNSS signals, offering a standardized guide for position, velocity, and time (PVT) technology organizations (or entities) to develop receivers capable of accurately processing the GNSS signals.

However, because the GNSS signals are unencrypted and overtly transmitted, the GNSS signals are vulnerable to spoofing (e.g., a malicious activity where deceptive signals are generated to mimic authentic GNSS signals). For example, spoofing involves transmission of counterfeit signals that mimic authentic GNSS signals, leading navigation receivers to calculate inaccurate PVT information. The absence of encryption means that the GNSS signals are not authenticated, and receivers may struggle to differentiate between genuine satellite transmissions and deceptive signals, which can lead to negative and harmful consequences. For example, spoofing can lead to misleading navigation information, safety risks in transportation, security concerns for organizational infrastructure, negative impacts on emergency services, and privacy concerns, among other examples.

Furthermore, typical security techniques used to enhance security associated with processing the GNSS signals only enable first-party verification (e.g., a receiver that generates a time and position solution can verify the time and position solution, but the time and position solution is not verified by a third-party). In other words, typical security techniques do not provide independent verification of a time and position solution generated by a receiver. As a result, third parties cannot rely on the time and position solutions generated and verified by the receiver.

Some implementations described herein enable third-party (e.g., independent) time and position authentication. As an example, an authentication equipment (AE) may receive an in-phase-quadrature phase (I/Q) spectrum recording of a covert data sequence indicative of received spectra of a signal over which an overt data sequence is transmitted and an overt time and position solution, derived from the overt data sequence, indicating a position and a time at which the position was derived. The AE may process the I/Q spectrum recording to derive an independent time and position solution indicating another position where the I/Q spectrum recording was recorded and another time at which the I/Q spectrum was recorded at the another position. The AE may determine, based on comparing the overt time and position solution and the independent time and position solution, whether the overt time and position solution and the independent time and position solution are a match. The AE may authenticate the overt time and position solution based on the overt time and position solution and the independent time and position solution being a match.

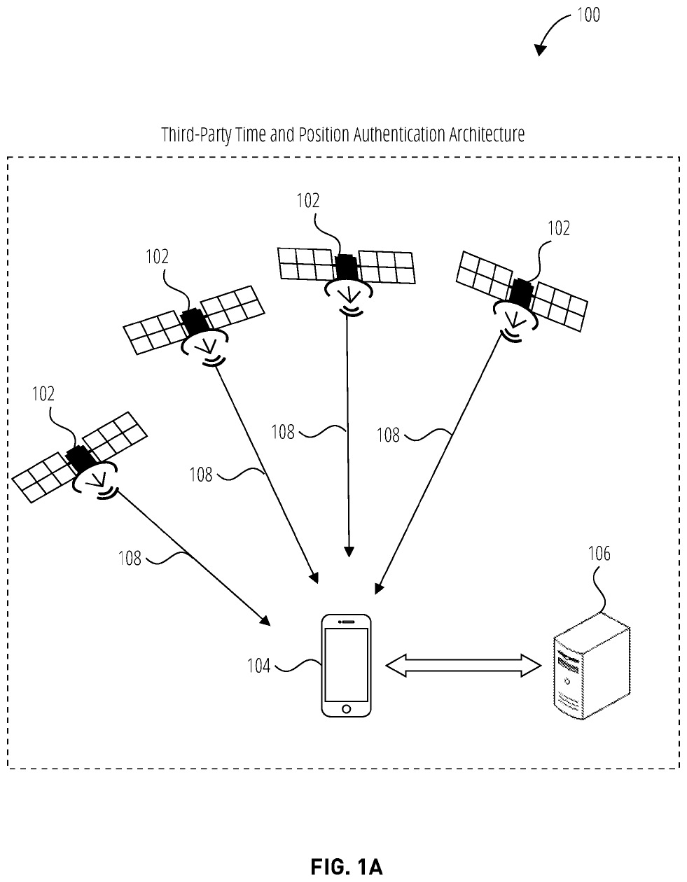

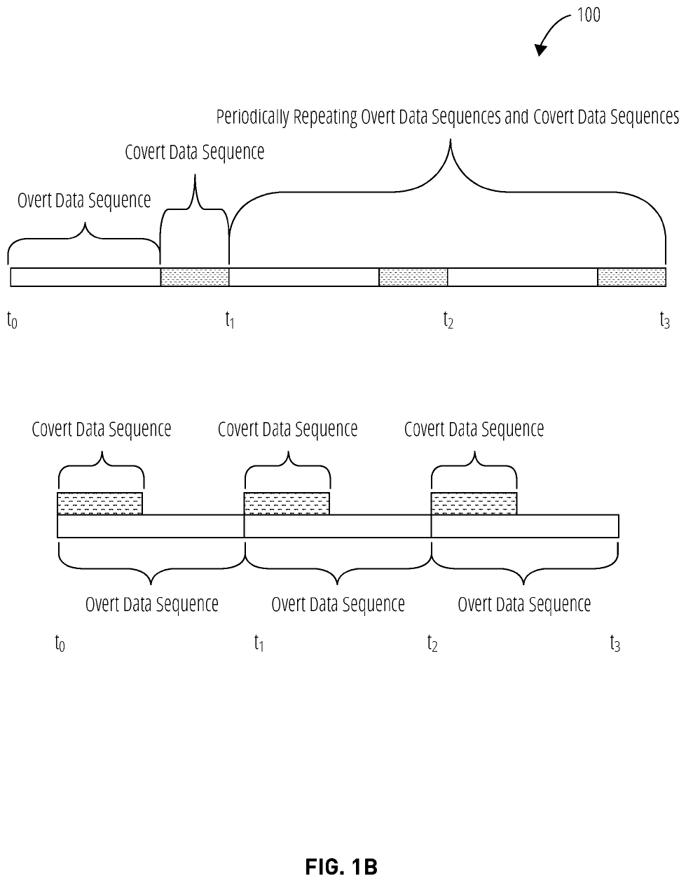

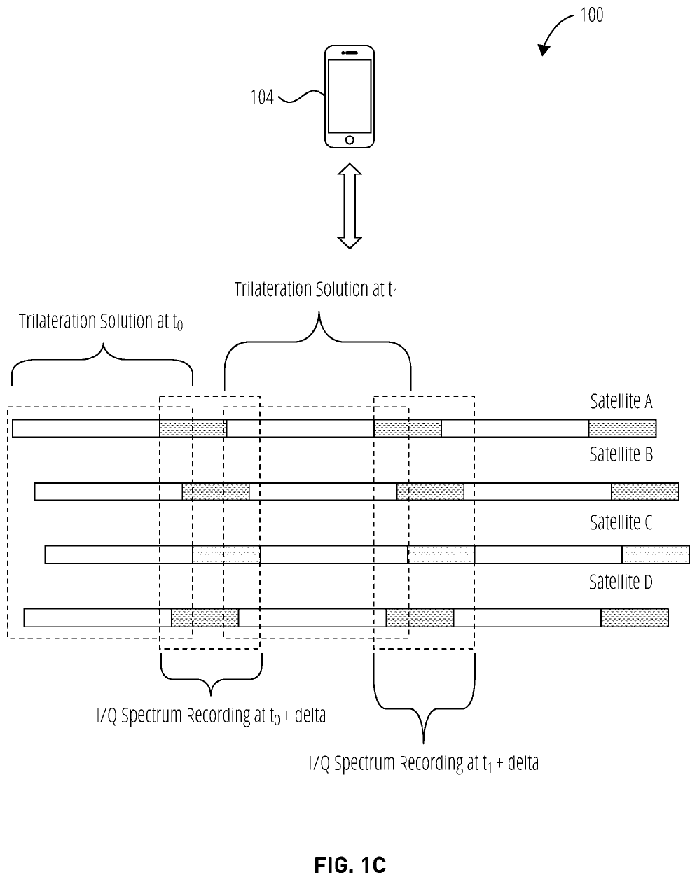

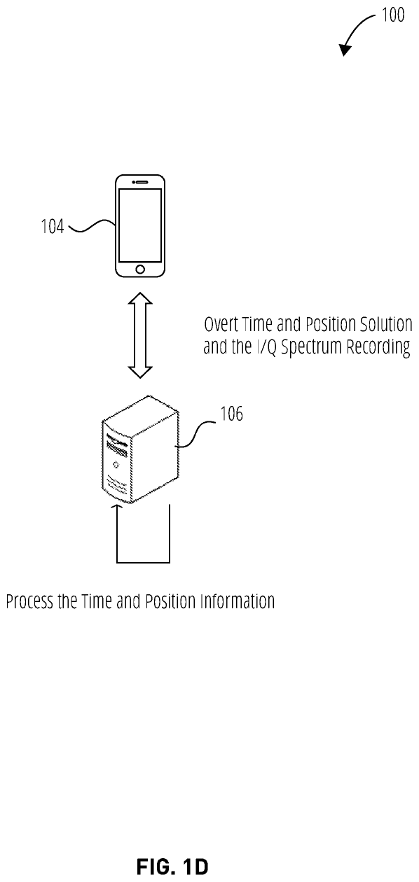

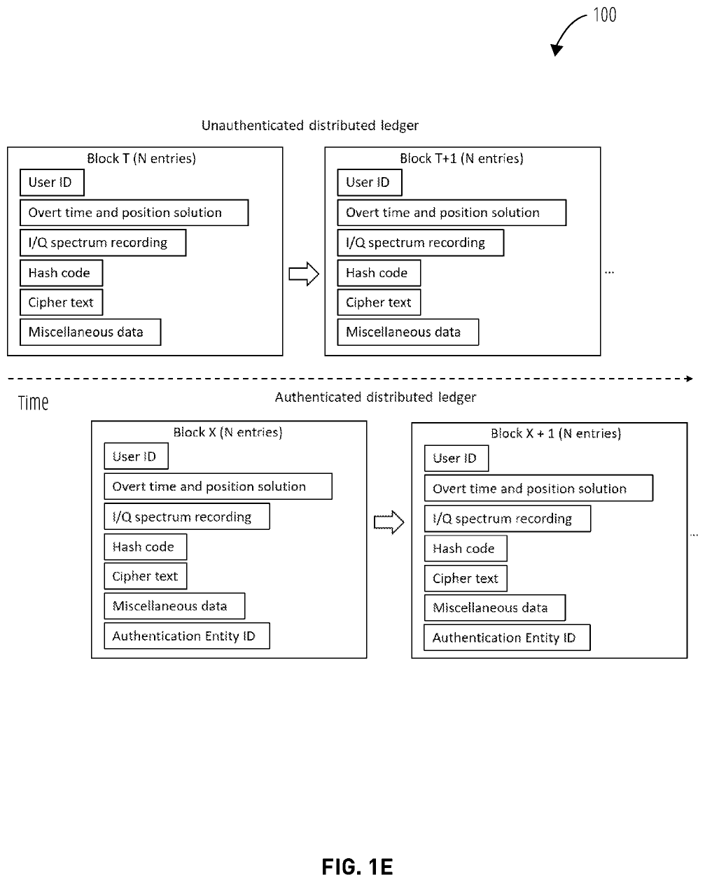

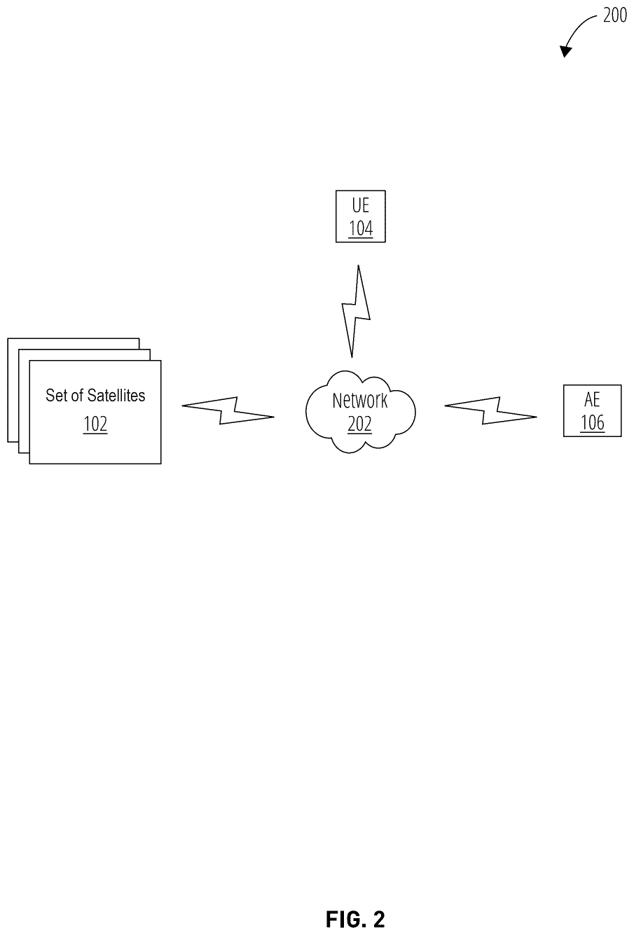

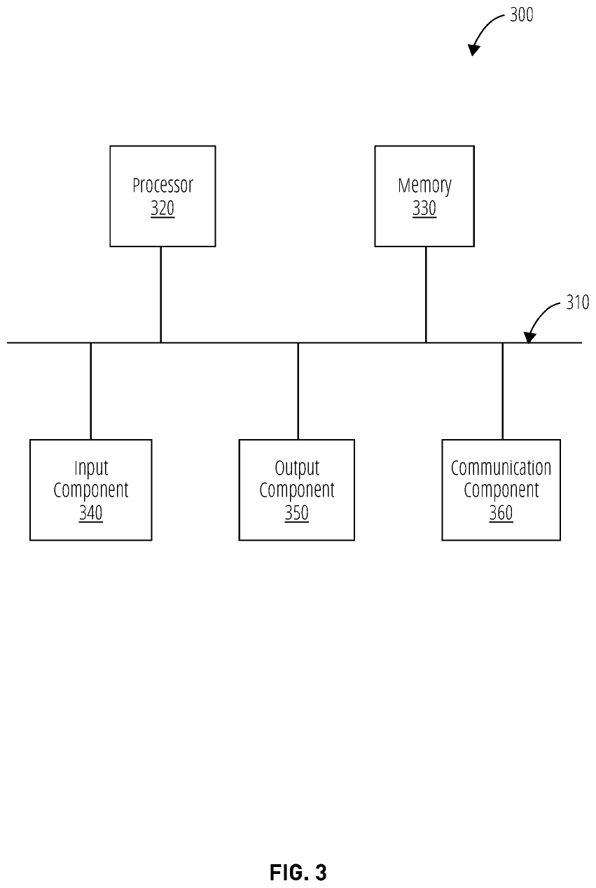

FIGS. 1A-1F are diagrams of an example 100 associated with third-party time and position authentication. As shown in FIGS. 1A-1F, example 100 includes a set of geolocation satellites (e.g., shown as a set of satellites 102 of a GNSS in FIG. 1A), a user equipment (UE) 104, and AE 106. In some implementations, the set of satellites 102, the UE 104, and the AE 106 form a third-party time and position authentication architecture (e.g., the UE 104 and/or the AE 106 may process the GNSS signals 108 to authenticate a time and position solution, as described in more detail elsewhere herein). These devices are described in more detail in connection with FIGS. 2 and 3.

As shown in FIG. 1A, the set of satellites 102 send, and the UE 104 receives, a set of GNSS signals 108, which may be referred to herein singularly as GNSS signal 108 and collectively as GNSS signals 108. Each GNSS signal 108, of the set of GNSS signals 108, may include an overt data sequence (e.g., a first data sequence) and a covert data sequence (e.g., a second data sequence). Time and position information may be derived from the overt data sequence, such as an overt time and position solution indicating a position and a time at which the position was derived. The covert data sequence may indicate, or be indicative of, received spectra of a signal over which the overt data sequence is transmitted.

Because the overt data sequence, transmitted by the set of satellites 102 using the set of GNSS signals 108, is an overt data sequence, the overt data sequence is easily observable or measurable by the UE 104 (or another device having access to a communication channel used to transmit the set of GNSS signals 108). Furthermore, because the covert data sequence, transmitted by the set of satellites 102 using the set of GNSS signals 108, is a covert data sequence, the UE 104 uses specialized knowledge or technology to detect, measure, and process the covert data sequence. For example, the UE 104 may use one or more preprocessing, demodulating, decoding, pattern recognition, decryption, and/or post-processing techniques to detect, measure, and process the covert data sequence.

In some implementations, the received spectra of the signal over which the overt data sequence is transmitted (e.g., indicated by the covert data sequence) may include information associated with a spectrum of the set of GNSS signals 108 that are received by the UE 104. As an example, the received spectra may include frequency domain information (e.g., associated with frequency components represented in the GNSS signals 108), amplitude information (e.g., associated with an amplitude of the GNSS signals 108 at each frequency), modulation characteristics (e.g., associated with a modulation scheme used to transmit the GNSS signals 108), transmission characteristics (e.g., associated with the transmission environment, noise levels, interference, and/or signal-to-noise ratio (SNR)), metadata and synchronization information (e.g., associated with synchronization and/or error correction), and/or timestamp information (e.g., associated with times that data of the GNSS signals 108 are received), among other examples.

Additionally, the overt data sequence and the covert data sequence may be transmitted on any suitable frequency and any suitable channel. For example, the overt data sequence and the covert data sequence may be transmitted on the same frequency within the same channel, may be transmitted on a different frequency within the same channel, may be transmitted on the same frequency within a different channel, or may be transmitted on a different frequency within a different channel. Additionally, or alternatively, the overt data sequence and the covert data sequence may be transmitted at the same time or sequentially.

In some implementations, and as shown in FIG. 1B, the overt data sequence and the covert data sequence form a two-sequence signal structure. In this way, the overt data sequence may be transmitted periodically (e.g., sequentially) or concurrently (e.g., as shown in FIG. 1B). Accordingly, the set of satellites 102 may periodically transmit the set of GNSS signals 108 such that the two-sequence signal structure is periodically transmitted or concurrently transmitted.

In some implementations, the UE 104 processes the overt data sequence and the covert data sequence (e.g., by using one or more PVT techniques, as described in more detail elsewhere herein). For example, the UE 104 processes the overt data sequence by deriving, from the overt data sequence, an overt time and position solution indicating a position of the UE 104 and a time at which the UE 104 was at the position. To derive the overt time and position solution, the UE 104 may perform a trilateration operation (or any other suitable position and time determination technique). As another example, the UE 104 processes the covert data sequence by performing an I/Q spectrum recording of the covert data sequence (e.g., a covert I/Q file). The I/Q spectrum recording includes hidden (e.g., covert) signals that are transmitted synchronized to the overt data sequence (e.g., associated with the overt time and positioning signals). The hidden signals allow for independent authentication of the overt time and position solution, as described in more detail elsewhere herein.

As shown in FIG. 1C, the UE 104 processes four GNSS signals 108 (e.g., a GNSS signal 108 transmitted by satellite A, a GNSS signal 108 transmitted by satellite B, a GNSS signal 108 transmitted by satellite C, and a GNSS signal 108 transmitted by satellite D). The UE 104 performs a trilateration operation, at a first time to, to generate a first overt time and position solution (e.g., a first overt in situ time and position solution). The UE 104 performs an I/Q spectrum recording operation, at a second time t₀+delta. to generate a first I/Q spectrum recording (e.g., a first in situ I/Q spectrum recording). As further shown in FIG. 1C, the UE 104 performs a trilateration operation, at a third time t₁, to generate a second overt time and position solution (e.g., a second overt in situ time and position solution). The UE 104 performs an I/Q spectrum recording operation, at a fourth time t₁+delta, to generate a second I/Q spectrum recording (e.g., a second in situ I/Q spectrum recording). The first overt time and position solution, the first I/Q spectrum recording, the second overt time and position solution, and the second I/Q spectrum recording may be included, among other information, in time and position information associated with the UE 104, as described in more detail elsewhere herein.

The UE 104 may provide the time and position information (e.g., the overt time and position solution and the I/Q spectrum recording, among other examples) to be entered into an entry of a database, such as a distributed ledger (e.g., a blockchain-based distributed ledger or non-block-chain based distributed ledger), as described in more detail elsewhere herein. As used herein, a distributed ledger is a decentralized database that uses one or more technologies and/or techniques to maintain a secure and decentralized record of information, such as information associated with transactions (e.g., transactions performed between two parties).

The distributed ledger may be consensually shared and synchronized across multiple sites, institutions, and/or participants in a network. The distributed ledger may be publicly available (e.g., the distributed ledger is at least available for viewing by each participant in the network) or may be private (e.g., the distributed ledger is made available to a select user community and is accessed via credentials). Changes to the distributed ledger are independently verified and agreed upon through a consensus mechanism (e.g., one or more cryptography and consensus mechanisms, among other examples). This maintains the integrity of the information entered into the distributed ledger and ensures that all participants have a consistent and up-to-date view of the information included in the distributed ledger. In this way, the distributed ledger may be used to create an unalterable, or immutable, ledger for tracking information, such as the time and position information provided the UE 104 and/or another equipment (e.g., the AE 106).

In some implementations, the time and position information, provided by the UE 104 to be entered into the distributed ledger entry of the distributed ledger, may include a user identification (e.g., a unique alphanumeric identifier associated with the UE 104 and/or a user of the UE 104), the overt time and position solution (e.g., that is generated by processing the overt data sequence), the I/Q spectrum recording (e.g., that is generated by processing the covert data sequence), and/or other desired information (e.g., that the user desires to be entered into the distributed ledger entry including miscellaneous data).

In some implementations, the UE 104 may digitally sign the time and position information to create a unique data representation of the time and position information (e.g., the UE 104 may digitally sign one or more portions of the time and position information to create one or more unique data representations of the one or more portions of the time and position information). As an example, the UE 104 may digitally sign the unique identifier of the UE 104, the overt time and position solution, and the I/Q spectrum recording to create a unique data representation of the unique identifier, the overt time and position solution and the I/Q spectrum recording.

As another example, the UE 104 may digitally sign the time and position information to create digitally signed time and position information, may digitally sign the overt time and position solution to create a digitally signed overt time and position solution, and/or may digitally sign the I/Q spectrum recording to create a digitally signed IQ spectrum recording. Additionally, or alternatively, the UE 104 may perform one or more hashing functions and/or one or more encrypting operations on the time and position information. As an example, the UE 104 may perform a hashing function on the user identification, the overt time and position solution, and the I/Q spectrum recording to generate a hash code of the user identification, the overt time and position solution, and the I/Q spectrum recording (e.g., which may be on the order of hundreds of bits or any suitable number of bits), among other examples. As another example, the UE 104 may perform an encrypting operation (e.g., using a private key associated with the UE 104 and/or the user of the UE 104) on the user identification, the overt time and position solution, and the I/Q spectrum recording to generate a cipher text of the user identification, the overt time and position solution, and the I/Q spectrum recording (e.g., which may be on the order of hundreds of bits or any suitable number of bits) among other examples.

In some implementations, the UE 104 may provide the digitally signed time and position information (and/or any other suitable data) to be entered into the unauthenticated distributed ledger entry of the unauthenticated distributed ledger. As an example, the UE 104 may send, and an equipment associated with the unauthenticated distributed ledger (e.g., not shown) many receive, the digitally signed time and position information. The equipment associated with the unauthenticated distributed ledger may process the digitally signed time and position information to add the digitally signed time and position information to the unauthenticated distributed ledger entry.

Furthermore, each unauthenticated distributed ledger entry may include digitally signed time and position information (and/or any other suitable data) associated with multiple UEs and/or users of the multiple UEs. In other words, digitally signed time and position information associated with multiple UEs and/or users of the multiple UEs may be included in a single unauthenticated distributed ledger entry. As an example, a single unauthenticated distributed ledger entry may include digitally signed time and position information provided by multiple UEs to be added to the single unauthenticated distributed ledger entry over a time period, such as 60 seconds or 120 seconds. The digitally signed time and position information included in the unauthenticated ledger entry may be authenticated, as described in more detail elsewhere herein.

As shown in FIG. 1D, the UE 104 sends, and the AE 106 receives, the overt time and position solution and the I/Q spectrum recording. The AE 106 may process the I/Q spectrum recording to derive an independent time and position solution indicating another position where the I/Q spectrum recording was recorded and another time at which the I/Q spectrum was recorded at the another position. The AE 106 may determine, based on comparing the overt time and position solution and the independent time and position solution, whether the overt time and position solution and the independent time and position solution are a match. The AE 106 may authenticate the overt time and position solution based on the overt time and position solution and the independent time and position solution being a match. The AE 106 may receive a request to authenticate the overt time and position solution. The AE 106 may provide an indication that the overt time and position solution is authentic.

In some implementations, the AE 106 may provide authenticated time and position information to be entered into an entry of a database, such as a distributed ledger (e.g., a blockchain-based distributed ledger or non-block-chain based distributed ledger). As an example, the AE 106 may provide the authenticated time and position information to be entered into an authenticated distributed ledger entry of an authenticated distributed ledger. The AE 106 may send, and an equipment associated with the authenticated distributed ledger (e.g., not shown) may receive, the authenticated time and position information. The equipment associated with the authenticated distributed ledger may process the authenticated time and position information to add the authenticated time and position information to the authenticated distributed ledger entry.

In some implementations, authenticated time and position information, provided by the AE 106 to be entered into the authenticated distributed ledger entry, may include an authentication entity identifier (an identifier of an authentication entity associated with the AE 106), the independent time and position solution, and/or unique data representations of the authenticated time and position information (e.g., the AE 106 may digitally sign one or more portions of the authenticated time and position information to create one or more unique data representations of the one or more portions of the authenticated time and position information).

As an example, the AE 106 may digitally sign the independent time and position solution to create digitally signed independent time and position solution data. As another example, the AE 106 may digitally sign the I/Q spectrum recording to create digitally signed IQ spectrum recording data. Additionally, or alternatively, the AE 106 may perform one or more hashing functions and/or one or more encrypting operations on the authenticated time and position information (in a similar or same manner as described in more detail elsewhere herein). The authenticated distributed ledger entry, including the authenticated time and position information provided by the AE 106, corresponds to the unauthenticated ledger entry that includes the overt time and position solution (and/or other time and position information associated with the UE 104 and/or the user of the UE 104) that the AE 106 authenticates.

As shown in FIG. 1E, Block T of the unauthenticated distributed ledger entry includes N number of entries having the unauthenticated time and position information (e.g., shown as the unauthenticated user ID, the overt time and position solution, the I/Q spectrum recording, the hash code, the cipher text, and the miscellaneous data). Block X of the authenticated distributed ledger entry includes N number of entries, corresponding to the N number of entries of Block T, having the authenticated time and position information (e.g., the authenticated user ID, the overt time and position solution, the I/Q spectrum recording, the hash code, the cipher text, and the miscellaneous data.

As further shown in FIG. 1E, Block T+1 of the unauthenticated distributed ledger entry includes N number of entries having the unauthenticated time and position information (e.g., shown as the unauthenticated user ID, the overt time and position solution, the I/Q spectrum recording, the hash code, the cipher text, and the miscellaneous data). Block X+1 of the authenticated distributed ledger entry includes N number of entries, corresponding to the N number of entries of Block T+1, having the authenticated time and position information (e.g., the authenticated user ID, the overt time and position solution, the I/Q spectrum recording, the hash code, the cipher text, and the miscellaneous data. Thus, the authenticated time and position is entered into the authenticated distributed ledger entry at a later time than when the unauthenticated time and position information was entered into the unauthenticated distributed ledger entry.

Accordingly, entries made into a distributed ledger (e.g., an unauthenticated distributed ledger and/or an authenticated distributed ledger) solidify a time and date in the past at which point the data in the entry existed. In this way, the entered data is at least as old as the distributed ledger entry and no younger. This creates a time boxing feature that can be described as a “no later than” time boxing feature.

Furthermore, covert data sequences may be unique, not repeatable, and random enough so as not to be predicted ahead of time by users of UEs and/or authentication entities, among other examples. A geolocation satellite system can then be configured to transmit a unique and random covert data sequence only once, at which time that data sequence enters the public domain for the first time. Any UE that obtains or possesses that covert data sequence, could not have received it prior to its transmission. If that covert data sequence is then used in some processing or transaction, then that process or transaction could inherently not have occurred prior to the release of the covert data sequence. This creates a time boxing feature that can be described as “no earlier than” time boxing feature. Additionally, if the covert data sequence (or a hash of the covert data sequence) is entered into a distributed ledger (e.g., an unauthenticated distributed ledger and/or an authenticated distributed ledger), this, combined the “not later than” time boxing feature and the “no earlier than” time boxing feature into a single instance, fully time boxing a process, entry, or transaction as having occurred no later than the entry in the distributed ledger and no earlier than the release or transmission of the covert data set into the public domain. In this way, the time and position information included in the unauthenticated distributed ledger entry and the time and position information included in the authenticated distributed ledger entry may be compared to verify the overt time and position solution indicating the position of the UE 104 and the time at which the UE 104 was at the position (or another position and time at which the position was derived).

Accordingly, the systems and methods described herein may be used for various purposes, such as provenance of material sourcing (e.g., to verify a position and a time corresponding to where wood was harvested, where fish were caught, what route an aircraft traveled, among other examples), position-based information technology (IT) access (e.g., enabling geofence access to certain databases, such as a company employee only being able to access employer IT services from a particular location), and/or deep fake protections (e.g., enabling authentication of a position where a video was made and a time at which the video was made).

FIG. 2 is a diagram of an example environment 200 in which systems and/or methods described herein may be implemented. As shown in FIG. 2, environment 200 may include a set of satellites 102 of a GNSS, a UE 104, an AE 106, and a network 202. Devices of environment 200 may interconnect via wired connections, wireless connections, or a combination of wired and wireless connections.

The set of satellites 102 may include a set, or constellation, of satellites in orbit (e.g., around Earth) that provide positioning, navigation, and timing information via the GNSS signals 108. The GNSS signals 108 may be received by ground-based receivers (e.g. the UE 104, the AE 106, and/or a transceiver device, among other examples), enabling accurate determination of positions and precise timekeeping.

The UE 104 may include one or more devices capable of receiving, generating, storing, processing, providing, and/or routing information associated with third-party time and position authentication, as described elsewhere herein. The UE 104 may include a communication device and/or a computer. For example, the UE 104 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset, among other examples), or a similar type of device.

The AE 106 may include a communication device and/or a computer. For example, the AE 106 may include a server, such as an application server, a client server, a web server, a database server, a host server, a proxy server, a virtual server (e.g., executing on computing hardware), or a server in a cloud computing system. In some implementations, the AE 106 may include computing hardware used in a cloud computing environment.

The network 202 may include one or more wired and/or wireless networks. For example, the network 202 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 202 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with third-party time and position authentication. The device 300 may correspond to the set of satellites 102, the UE 104, and/or the AE 106. In some implementations, the set of satellites 102, the UE 104, and/or the AE 106 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver device, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

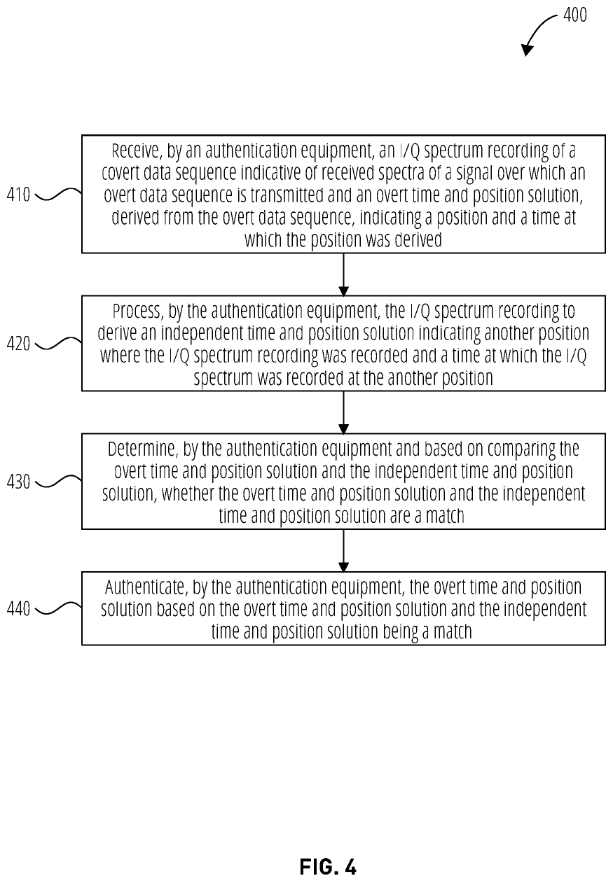

FIG. 4 is a flowchart of an example process 400 associated with third-party time and position authentication. In some implementations, one or more process blocks of FIG. 4 may be performed by the AE 106. In some implementations, one or more process blocks of FIG. 4 may be performed by another device (e.g., the UE 104) or a group of devices separate from or including the AE 106. Additionally, or alternatively, one or more process blocks of FIG. 6 may be performed by one or more components of the device 300, such as the processor 320, the memory 330, the input component 340, the output component 340, and/or the communication component 460.

As shown in FIG. 4, the process 400 includes receiving, by the AE 106, an I/Q spectrum recording of a covert data sequence indicative of received spectra of a signal over which an overt data sequence is transmitted and an overt time and position solution, derived from the overt data sequence, indicating a position and a time at which the position was derived (block 410), as described above.

As further shown in FIG. 4, the process 400 includes processing, by the AE 106, the I/Q spectrum recording to derive an independent time and position solution indicating another position where the I/Q spectrum recording was recorded and another time at which the I/Q spectrum was recorded at the another position (block 420), as described above.

As further shown in FIG. 4, the process 400 includes determining, by the AE 106 and based on comparing the overt time and position solution and the independent time and position solution, whether the overt time and position solution and the independent time and position solution are a match (block 430), as described above

As further shown in FIG. 4, the process 400 includes authenticating, by the AE 106, the overt time and position solution based on the overt time and position solution and the independent time and position solution being a match (block 440), as described above.

Although FIG. 4 shows example blocks of the process 400, in some implementations, the process 400 may include additional blocks, fewer blocks, different blocks, or differently arranged blocks than those depicted in FIG. 4. Additionally, or alternatively, two or more of the blocks of process 400 may be performed in parallel.

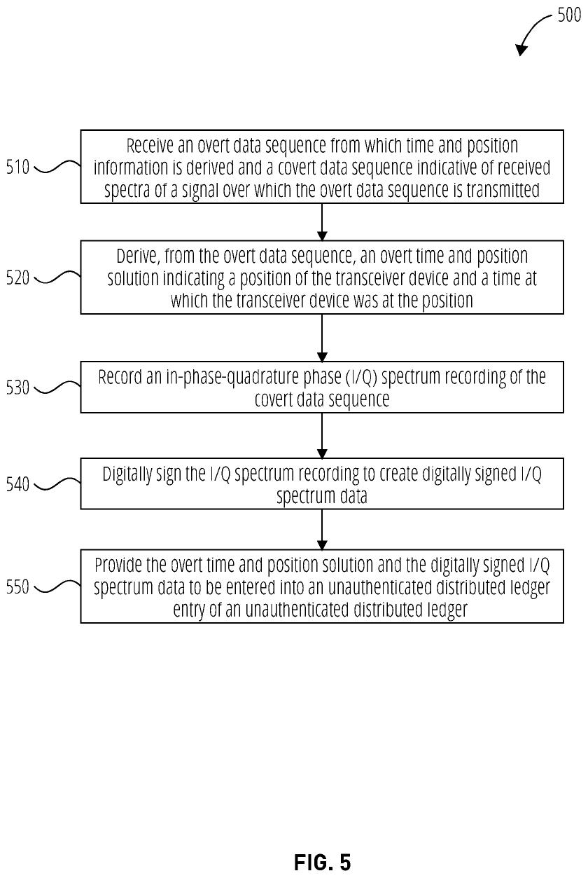

FIG. 5 is a flowchart of an example process 500 associated with third-party time and position authentication. In some implementations, one or more process blocks of FIG. 5 may be performed by the UE 104. In some implementations, one or more process blocks of FIG. 5 may be performed by another device (e.g., the AE 106 and/or another UE) or a group of devices separate from or including the UE 104. Additionally, or alternatively, one or more process blocks of FIG. 5 may be performed by one or more components of the device 300, such as the processor 320, the memory 330, the input component 340, the output component 340, and/or the communication component 460.

As shown in FIG. 5, the process 500 includes receiving an overt data sequence from which time and position information is derived and a covert data sequence indicative of received spectra of a signal over which the overt data sequence is transmitted (block 510), as described above.

As further shown in FIG. 5, the process 500 includes deriving, from the overt data sequence, an overt time and position solution indicating a position of the transceiver device and a time at which the transceiver device was at the position (block 520), as described above.

As further shown in FIG. 5, the process 500 includes recording an in-phase-quadrature phase (I/Q) spectrum recording of the covert data sequence (block 530), as described above.

As further shown in FIG. 5, the process 500 includes digitally signing the I/Q spectrum recording to create digitally signed I/Q spectrum data (block 540), as described above.

As further shown in FIG. 5, the process 500 includes providing the overt time and position solution and the digitally signed I/Q spectrum data to be entered into an unauthenticated distributed ledger entry of an unauthenticated distributed ledger (block 550), as described above.

Although FIG. 5 shows example blocks of the process 500, in some implementations, the process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by an authentication equipment, an in-phase-quadrature phase (I/Q) spectrum recording of a covert data sequence indicative of received spectra of a signal over which an overt data sequence is transmitted and an overt time and position solution, derived from the overt data sequence, indicating a position and a time at which the position was derived;
processing, by the authentication equipment, the I/Q spectrum recording to derive an independent time and position solution indicating another position where the I/Q spectrum recording was recorded and another time at which the I/Q spectrum was recorded at the another position;
determining, by the authentication equipment and based on comparing the overt time and position solution and the independent time and position solution, whether the overt time and position solution and the independent time and position solution are a match; and
authenticating, by the authentication equipment, the overt time and position solution based on the overt time and position solution and the independent time and position solution being a match.

2. The method of claim 1, further comprising:
receiving, by the authentication equipment, a request to authenticate the overt time and position solution; and
providing, by the authentication equipment, an indication that the overt time and position solution is authentic.

3. The method of claim 1, further comprising:
digitally signing, by the authentication equipment, the I/Q spectrum recording to create digitally signed I/Q spectrum data;
digitally signing, by the authentication equipment, the independent time and position solution to create digitally signed independent time and position solution data; and
providing, by the authentication equipment, the digitally signed I/Q spectrum data and the digitally signed independent time and position solution data to be entered into an authenticated distributed ledger entry of an authenticated distributed ledger,
wherein the authenticated distributed ledger entry corresponds to an unauthenticated ledger entry of an unauthenticated distributed ledger indicating the digitally signed I/Q spectrum data and a digitally signed overt time and position solution that matches the digitally signed independent time and position data, and
wherein the unauthenticated distributed ledger entry was entered into the unauthenticated distributed ledger earlier in time than when the authenticated distributed ledger entry was entered into the authenticated distributed ledger.

4. The method of claim 3, further comprising:
receiving, by the authentication equipment, a request to authenticate the overt time and position solution; and
providing, by the authentication equipment, a message including:
an identifier of the unauthenticated ledger entry that enables retrieval of the digitally signed overt time and position data and the digitally signed I/Q spectrum data from the unauthenticated ledger entry, and
an identifier of the authenticated ledger entry that enables retrieval of the digitally signed independent time and position data and the digitally signed I/Q spectrum data from the authenticated ledger entry.

5. The method of claim 1, wherein the covert data sequence and the overt data sequence are included in a geolocation satellite signal.

6. The method of claim 1, wherein the position and the time at which the position was derived corresponds to transaction.

7. The method of claim 1, wherein the covert data sequence includes at least one of:
a unique structure,
a unique bandwidth,
a unique signal strength,
a unique polarization,
a unique modulation,
a unique encoding, or
a unique encryption.

8. A transceiver device, comprising:
one or more memories; and
one or more processors, communicatively coupled to the one or more memories, configured to:
receive an overt data sequence and a covert data sequence indicative of received spectra of a signal over which the overt data sequence is transmitted;
derive, from the overt data sequence, an overt time and position solution indicating a position of the transceiver device and a time at which the transceiver device was at the position;
record an in-phase-quadrature phase (I/Q) spectrum recording of the covert data sequence;
digitally sign a unique identifier of the transceiver device, the overt time and position solution, and the I/Q spectrum recording to create a unique data representation of the unique identifier, the overt time and position solution and the I/Q spectrum recording; and
provide the unique data representation to be entered into an unauthenticated distributed ledger entry of an unauthenticated distributed ledger.

9. The transceiver device of claim 8, wherein the one or more processors are configured to:
provide the I/Q spectrum recording and the overt time and position solution.

10. The transceiver device of claim 8, wherein the one or more processors are configured to:
encrypt the unique data representation.

11. The transceiver device of claim 8, wherein the one or more processors, to digitally sign the unique identifier of the transceiver device, the overt time and position solution, and the I/Q spectrum recording to create the unique data representation of the unique identifier of the transceiver device, the overt time and position solution, and the digitally signed I/Q spectrum data, are configured to:
hash, using a hashing algorithm, the unique identifier of the transceiver device, the overt time and position solution, and the I/Q spectrum recording to create a hashed representation of the unique identifier of the transceiver device, the overt time and position solution, and the I/Q spectrum recording.

12. The transceiver device of claim 11, wherein the hashing algorithm is Secure Hash Algorithm 3 (SHA-3).

13. The transceiver device of claim 8, wherein the one or more processors are configured to:
send a request to verify the overt time and position solution; and
receive, in response to the request, an indication that the overt time and position solution is authentic.

14. A non-transitory computer-readable medium storing a set of instructions, the set of instructions comprising:
one or more instructions that, when executed by one or more processors of an authentication equipment, cause the authentication equipment to:
receive an in-phase-quadrature phase (I/Q) spectrum recording of a covert data sequence indicative of received spectra of a signal over which an overt data sequence is transmitted and an overt time and position solution, derived from the overt data sequence, indicating a position and a time at which the position was derived;
process the I/Q spectrum recording to derive an independent time and position solution indicating a position where the I/Q spectrum recording was recorded and a time at which the I/Q spectrum was recorded at the position;
determine, based on comparing the overt time and position solution and the independent time and position solution, whether the overt time and position solution and the independent time and position solution are a match; and
authenticate the overt time and position solution based on the overt time and position solution and the independent time and position solution being a match.

15. The non-transitory computer-readable medium of claim 14, wherein the one or more instructions, when executed by the one or more processors, cause the authentication equipment to:
receive a request to authenticate the overt time and position solution; and
provide an indication that the overt time and position solution is authentic.

16. The non-transitory computer-readable medium of claim 14, wherein the one or more instructions, when executed by the one or more processors, cause the authentication equipment to:
digitally sign the I/Q spectrum recording to create digitally signed I/Q spectrum data;
digitally sign the independent time and position solution to create digitally signed independent time and position solution data; and
provide the digitally signed I/Q spectrum data and the digitally signed independent time and position solution data to be entered into an authenticated distributed ledger entry of an authenticated distributed ledger,
wherein the authenticated distributed ledger entry corresponds to an unauthenticated ledger entry of an unauthenticated distributed ledger indicating the digitally signed I/Q spectrum data and the overt time and position solution that matches the digitally signed independent time and position data, and
wherein the unauthenticated distributed ledger entry was entered into the unauthenticated distributed ledger earlier in time than when the authenticated distributed ledger entry was entered into the authenticated distributed ledger.

17. The non-transitory computer-readable medium of claim 16, wherein the one or more instructions, when executed by the one or more processors, cause the authentication equipment to:
receive a request to authenticate the overt time and position solution; and
provide a message including:
an identifier of the unauthenticated ledger entry that enables retrieval of the digitally signed overt time and position data and the digitally signed I/Q spectrum data from the unauthenticated ledger entry, and
an identifier of the authenticated ledger entry that enables retrieval of the digitally signed independent time and position data and the digitally signed I/Q spectrum data from the authenticated ledger entry.

18. The non-transitory computer-readable medium of claim 14, wherein the covert data sequence and the overt data sequence are included in a geolocation satellite signal.

19. The non-transitory computer-readable medium of claim 14, wherein the position and the time at which the position was derived corresponds to transaction.

20. The non-transitory computer-readable medium of claim 14, wherein the covert data sequence includes at least one of:
a unique structure,
a unique bandwidth,
a unique signal strength,
a unique polarization,
a unique modulation,
a unique encoding, or
a unique encryption.
